(19) United States
(12) Patent Application Publication
(10) Pub. No.: US 2025/0389230 A1
(43) Pub. Date: Dec. 25, 2025

(54) COMPRESSOR BYPASS FOR LOW ALTITUDE OPERATIONS

(71) Applicants: Rudolf COERTZE, Gloucestershire (GB); Asif SADIK, Gloucestershire (GB); Christian BAILEY, Hollister, CA (US); Gabriel DEVAULT, Gloucestershire (GB); Kevin-Patxi LE BRAS, Hollister, CA (US); Bob L. MACKEY, Hollister, CA (US); ZeroAvia Ltd, Cirencester (GB)

(72) Inventors: Rudolf COERTZE, Cirencester (GB); Asif SADIK, Cirencester (GB); Christian BAILEY, Hollister, CA (US); Gabriel DEVAULT, Cirencester (GB); Kevin-Patxi LE BRAS, Hollister, CA (US); Bob L. MACKEY, Hollister, CA (US)

(21) Appl. No.: 18/878,442

(22) PCT Filed: Jun. 23, 2022
(86) PCT No.: PCT/US2022/073128

§ 371 Date: Dec. 23, 2024

(51) Int. Cl. F01D 15/10; F02C 3/22; F02C 9/22

(52) U.S. Cl. CPC F02C 9/18; B64D 27/33; F02C 3/22; F02C 7/143

(57) ABSTRACT

An integrated hydrogen-electric engine includes, an air compressor system; a hydrogen fuel source; a fuel cell; an elongated shaft connected to the air compressor system or a propulsor; and a motor assembly disposed in electrical communication with the fuel cell, wherein the air compressor system includes a plurality of electrically driven compressors configured to run in series or parallel.

The present disclosure relates integrated hydrogen fuel cell electric engine systems. The disclosure has particular utility to hydrogen fuel cell electric engines for use with transport vehicles including aircraft and will be described in connection with such utility, although other utilities are contemplated.

Exhaust emissions from transport vehicles are a significant contributor to climate change. Conventional fossil fuel powered aircraft engines release CO₂ emissions. Also fossil fuel powered aircraft emissions include non-CO₂ effects due to nitrogen oxide (NOx), vapor trails and cloud formation triggered by the altitude at which aircraft operate. These non-CO₂ effects are believed to contribute twice as much to global warming as aircraft CO₂ and were estimated to be responsible for two thirds of aviation's climate impact. Additionally, the high-speed exhaust gasses of conventional fossil fuel powered aircraft engines contribute significantly to the extremely large noise footprint of commercial and military aircraft, particularly in densely populated areas.

Moreover, in surveillance and defense applications, the high engine noise and exhaust temperatures of conventional fossil fuel burning engines significantly hamper the ability of aircraft to avoid detection and therefore reduce the mission capabilities of the aircraft.

Rechargeable battery powered terrestrial vehicles, i.e., “EVs” are slowly replacing conventional fossil fuel powered terrestrial vehicles. However, the weight of batteries and limited energy storage of batteries makes rechargeable battery powered aircraft generally impractical.

Hydrogen fuel cells offer an attractive alternative to fossil fuel burning engines. Hydrogen fuel cell tanks may be quickly filled and store significant energy, and other than the relatively small amount of unreacted hydrogen gas, the exhaust from hydrogen fuel cells comprises essentially only water.

In our co-pending U.S. application Ser. No. 16/950,735 filed Nov. 17, 2020, the contents of which are incorporated herein by reference we disclose an integrated hydrogen-electric engine that reduces aircraft noise and heat signatures of conventional fossil fuel burning engines, improves component reliability, increases the useful life of the engine, limits environmental pollution, and decreases the probability of failure per hour of operation. In particular, we disclose an integrated turboshaft engine with a multi-stage compressor similar to current turboshaft engines in the front, but with the remaining components replaced with a fuel cell system that utilizes compressed air and compressed hydrogen to produce electricity that powers motors on an elongated shaft to deliver useful mechanical power to a propulsor (e.g., a fan or propeller). Part of the generated power can be utilized to drive the multi-stage compressor. This architecture delivers very high-power density and is able to deliver similar power density to modern jet engines (e.g., 6-8 kW/kg) at a preceompression ratio of 30+ (common in today's turbofan engines).

While the integrated hydrogen-electric engine described in our aforesaid U.S. application Ser. No. 16/950,735 provides a technically and commercially viable solution to the aforesaid and other disadvantages of conventional fossil fuel burning engines, sizing the compressors to provide sufficient oxygen to the fuel cell at high altitudes where the air is less dense results in their being oversized for operation on the ground and below a certain altitude, for example 10,000 ft above mean sea level (MSL).

In order to overcome the aforesaid and other problems of the prior art, in accordance with the present disclosure, we provide a system, i.e., method and apparatus, for selectively varying the airflow into the fuel cell of a fuel cell powered engine.

In one aspect of the disclosure we provide an integrated hydrogen-electric engine comprising: an air compressor system; a hydrogen fuel source; a fuel cell; an elongated shaft connected to the air compressor system and/or a propulsor; and a motor assembly disposed in electrical communication with the fuel cell, wherein the air compressor system includes a plurality of electrically driven compressors configured to run in series. In such aspect, the plurality of electrically driven compressors preferably are connected through valves, and may include a controller configured to control operation of the valves.

In another aspect of the disclosure we provide an integrated hydrogen-electric engine comprising: an air compressor system; a hydrogen fuel source; a fuel cell; an elongated shaft connected to the air compressor system and/or a propulsor and a motor assembly disposed in electrical communication with the fuel cell, wherein the air compressor system includes a plurality of compressors configured to run in parallel. In such aspect the plurality of compressors preferably are coaxially arranged on the elongated shaft, wherein the plurality of compressors have variable pitch vanes or variable inlet guide vanes, and may include a controller configured to control operation of the variable pitch vanes or variable inlet guide vanes.

In yet another aspect of the disclosure, we provide an integrated hydrogen-electric engine comprising: an air compressor system; a hydrogen fuel source; a fuel cell; an elongated shaft connected to the air compressor system and/or a propulsor; and a motor assembly disposed in electrical communication with the fuel cell, wherein the air compressor system comprises a plurality of bladed compressors axially arranged on the elongated shaft, and further including one or more air inlets and/or outlets configured to open and close to selectively alter air flow across the compressor blades. In such aspect the integrated hydrogen-electric engine may include a controller configured for controlling operation of the inlets and outlets, and compressors preferably comprise centrifugal compressors.

In yet another aspect of the disclosure we provide an integrated hydrogen-electric engine comprising: an air compressor system; a hydrogen fuel source; a fuel cell; an elongated shaft connected to the air compressor system and/or a propulsor; and a motor assembly disposed in electrical communication with the fuel cell, wherein the air compressor system includes a centrifugal air compressor driven by the elongated shaft, and an electrically-driven air compressor, configured to boost the centrifugal air compressor. In such aspect, the electrically-driven compressor preferably is connected to an inlet of the centrifugal compressor through valves, and the engine further preferably includes a controller configured to control operation of the valves.

In still yet another aspect of the disclosure there is provided an integrated bydrogen-electric engine comprising a two-stage turbocell including a first turbocell and a second turbocell, wherein each turbocell stage comprises: an air compressor system; a hydrogen fuel source; a fuel cell; an elongated shaft connected to the air compressor system and/or a propulsor; and a motor assembly disposed in electrical communication with the fuel cell, wherein the elongated shaft of the first turbocell and the elongated shaft of the second turbocell are configured to run independently and coaxially with one another. In such aspect the first turbocell and/or the second turbocell preferably are configured to be driven by a supplemental electrical motor or a turbine driven by fuel cell exhaust. Also preferably included is a controller configured to control operation of the electric motor or turbine.

In yet a further aspect of the disclosure there is provided an integrated hydrogen-electric engine comprising: an air compressor system; a hydrogen fuel source; a fuel cell; an elongated shaft connected to the air compressor system and/or a propulsor; a motor assembly disposed in electrical communication with the fuel cell; and an electric starter motor configured to start the integrated hydrogen-electric engine spinning. In such aspect, the electric motor is battery powered, and may include a controller configured to activate/deactivate the electronic starter motor comprising a relatively low voltage (e.g., 12v to 24v) electric motor.

According to a first aspect of the present invention there is provided an integrated hydrogen-electric engine comprising: an air compressor system; a hydrogen fuel source; a fuel cell; an elongated shaft connected to the air compressor system and/or a propulsor; and a motor assembly disposed in electrical communication with the fuel cell, wherein the air compressor system includes one or more of: a) a plurality of electrically driven compressors configured to run in series; b) a plurality of compressors configured to run in parallel; c) a plurality of bladed compressors axially arranged on the elongated shaft, and further including one or more air inlets and/or outlets configured to open and close to selectively alter air flow across the compressor blades; d) a centrifugal air compressor driven by the elongated shaft, and an electrically driven air compressor, configured to boost the centrifugal air compressor.

Preferably the plurality of electrically driven compressors are connected via valves.

Preferably the integrated hydrogen-electric engine further includes a controller configured to control operation of the valves.

Preferably the plurality of compressors are coaxially arranged on the elongated shaft, wherein the plurality of compressors have variable pitch vanes or variable inlet guide vanes.

Preferably the integrated hydrogen-electric engine further includes a controller configured to control operation of the variable pitch vanes or variable inlet guide vanes.

Preferably the integrated hydrogen-electric engine further includes a controller configured for controlling operation of the inlets and outlets.

Preferably the compressors comprise centrifugal compressors.

Preferably the electrically driven compressor is connected to an inlet of the centrifugal compressor through valves.

Preferably the integrated hydrogen-electric engine further includes a controller configured to control operation of the valves.

Preferably the integrated hydrogen-electric engine comprises a two-stage turbocell including a first turbocell and a second turbocell, wherein each turbocell stage comprises: an air compressor system; a hydrogen fuel source; a fuel cell; an elongated shaft connected to the air compressor system and/or a propulsor; and a motor assembly disposed in electrical communication with the fuel cell, wherein the elongated shaft of the first turbocell and the elongated shaft of the second turbocell are configured to run independently and coaxially with one another.

Preferably the first turbocell and/or the second turbocell are configured to be driven by a supplemental electrical motor or a turbine driven by fuel cell exhaust.

Preferably the integrated hydrogen-electric engine further comprises a controller configured to control operation of the electric motor or turbine.

Preferably an electric starter motor configured to start the integrated hydrogen-electric engine spinning.

Preferably the electric motor is battery powered.

Preferably the integrated hydrogen-electric engine further comprises a controller configured to control operation of the electric motor or turbine.

Preferably the electric starter motor comprises a low voltage electric motor.

According to a second aspect of the present invention there is provided an integrated hydrogen-electric engine comprising a two-stage turbocell including a first turbocell and a second turbocell, wherein each turbocell stage comprises: an air compressor system; a hydrogen fuel source; a fuel cell; an elongated shaft connected to the air compressor system and/or a propulsor; and a motor assembly disposed in electrical communication with the fuel cell, wherein the elongated shaft of the first turbocell and the elongated shaft of the second turbocell are configured to run independently and coaxially with one another.

Preferably the first turbocell and/or the second turbocell are configured to be driven by a supplemental electrical motor or a turbine driven by fuel cell exhaust.

Preferably the integrated hydrogen-electric engine further comprises a controller configured to control operation of the electric motor or turbine.

Preferably an electric starter motor configured to start the integrated hydrogen-electric engine spinning.

Preferably the electric motor is battery powered.

Preferably the integrated hydrogen-electric engine further comprises a controller configured to control operation of the electric motor or turbine.

Preferably the electric starter motor comprises a low voltage electric motor.

According to a third aspect of the present invention there is provided an integrated hydrogen-electric engine comprising: an air compressor system; a hydrogen fuel source; a fuel cell; an elongated shaft connected to the air compressor system and/or a propulsor; a motor assembly disposed in electrical communication with the fuel cell; and an electric starter motor configured to start the integrated hydrogen-electric engine spinning.

Preferably the electric motor is battery powered.

Preferably the integrated hydrogen-electric engine further comprises a controller configured to control operation of the electric motor or turbine.

Preferably the electric starter motor comprises a low voltage electric motor.

Further features and advantages of the subject disclosure will be seen from the following detailed description, taken in conjunction with the accompanying drawings, wherein:

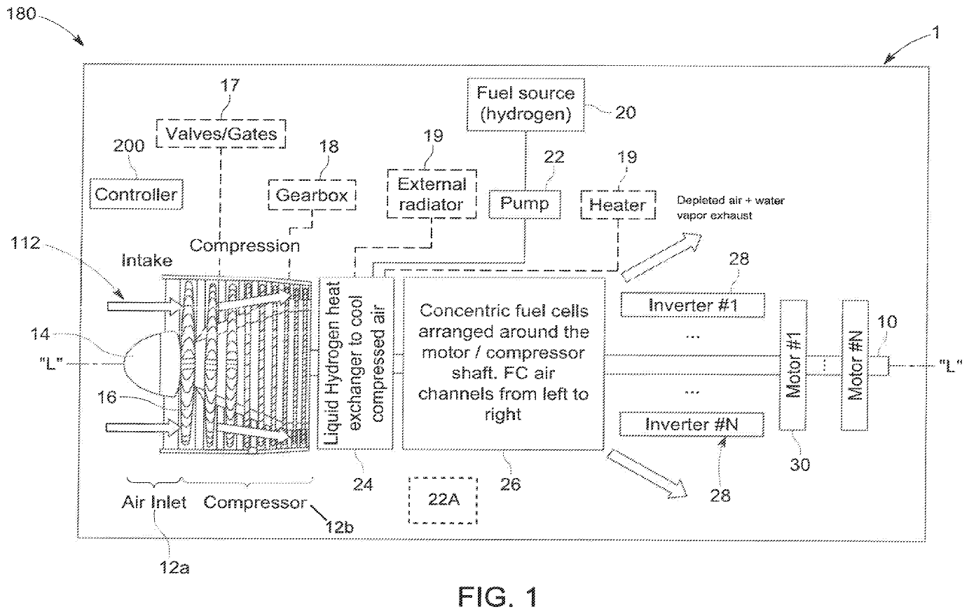

FIG. 1 is schematic view of an integrated hydrogen fuel cell-electric engine system in accordance with our prior U.S. application Ser. No. 16/950,735;

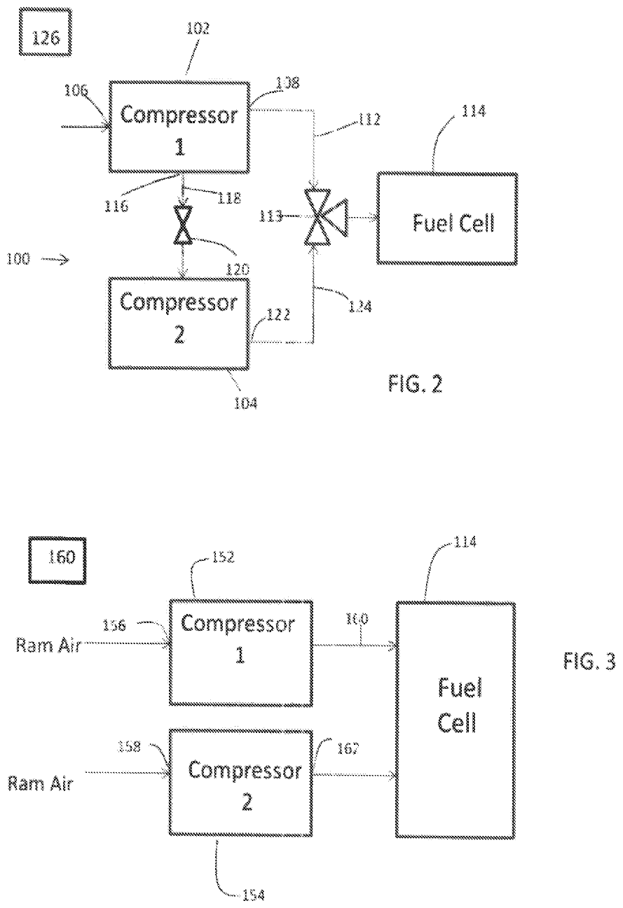

FIG. 2 is a schematic view of the air compressor or “front end” of an integrated hydrogen-fuel cell electric engine system in accordance with the present disclosure;

FIG. 3 is a view, similar to FIG. 2 of an alternative embodiment of an integrated hydrogen fuel cell-electric engine system in accordance with the present disclosure;

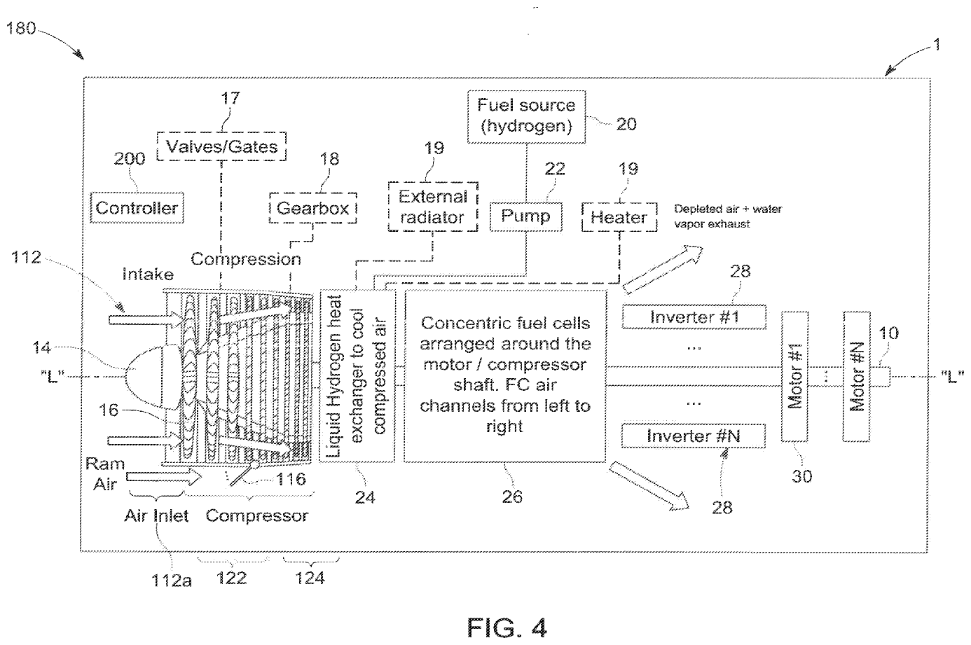

FIG. 4 is a schematic view, similar to FIG. 1, of an alternative embodiment of an integrated hydrogen fuel cell-electric engine system in accordance with the present disclosure;

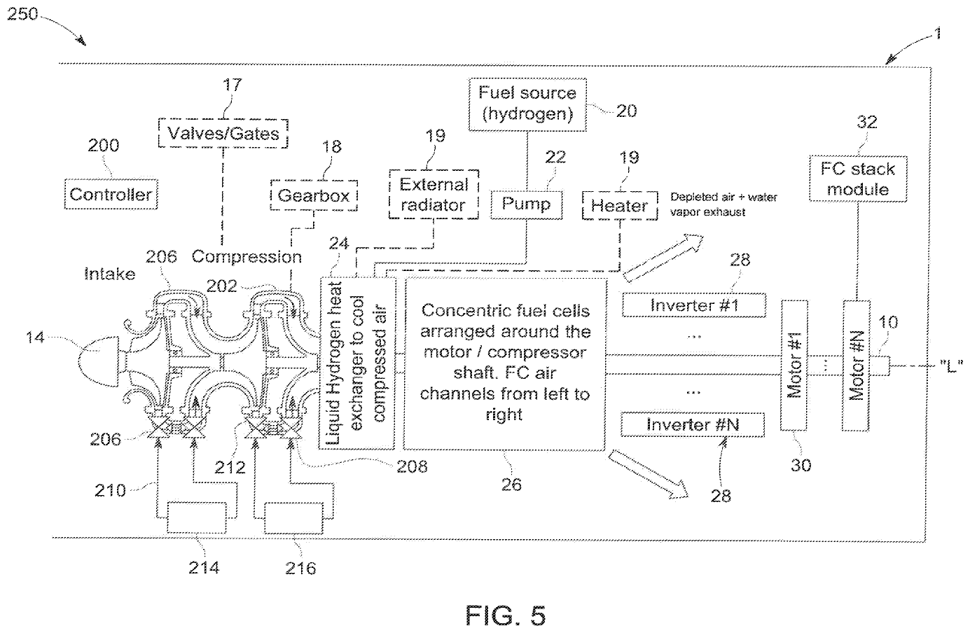

FIG. 5 is a schematic view similar to FIG. 1, in yet another embodiment of an integrated hydrogen fuel cell-electric engine system in accordance with the present disclosure;

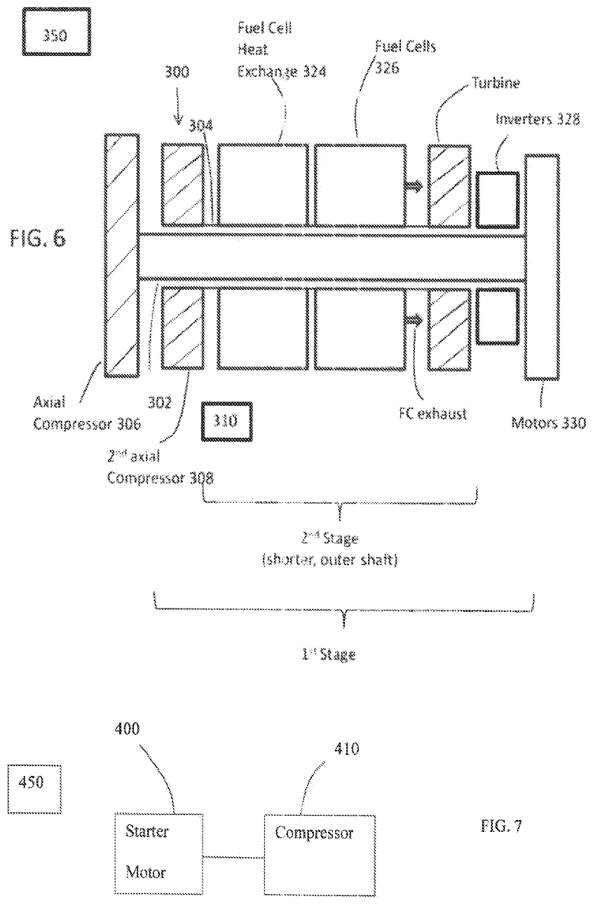

FIG. 6 is a schematic view of still yet another embodiment of an integrated hydrogen fuel cell-electric engine system in accordance with the present disclosure; and

FIG. 7 is a schematic view of still yet another embodiment of an integrated hydrogen fuel cell-electric engine system in accordance with the present disclosure.

FIG. 1 illustrates an integrated hydrogen-electric engine system 1 that can be utilized, for example, in a turboprop or turbofan system, to provide a streamlined, light-weight, power-dense and efficient system, in accordance with our aforesaid U.S. application Ser. No. 16/950,735. In general, integrated hydrogen-electric engine system 1 includes an elongated shaft 10 that defines a longitudinal axis “L” and extends through the entire powertrain of integrated hydrogen-electric engine system 1 to function as a common shaft for the various components of the powertrain. Elongated shaft 10 supports propulsor 14 (e.g., a fan or propeller) and a multi-stage air compressor system 12, a pump 22 in fluid communication with a fuel source (e.g., liquid hydrogen), a heat exchanger 24 in fluid communication with air compressor system 12, a fuel cell 26 (e.g., a fuel cell stack) in fluid communication with heat exchanger 24, and a motor assembly 30 disposed in electrical communication with inverters 28. Alternatively, one or more components e.g., pump 22A shown in phantom may be electrically driven by output from fuel cell 26.

Propulsor 14 includes an air inlet portion 12a at a front end thereof and a compressor portion 12b that is disposed proximally of air inlet portion 12a for uninterrupted, axial delivery of air flow in the proximal direction. Compressor portion 12b supports a plurality of longitudinally spaced-apart rotatable bladed compressor wheels 16 (e.g., multi-stage) that rotate in response to rotation of elongated shaft 10 for compressing air received through air inlet portion 12a for pushing the compressed air to a fuel cell 26 for conversion to electrical energy. As can be appreciated, the number of compressor wheels/stages 16 and/or diameter, longitudinal spacing, and/or configuration thereof can be modified as desired to change the amount of air supply, and the higher the power, the bigger the propulsor 14. These compressor wheels 16 can be implemented as axial or centrifugal compressor stages. Further, the compressor can have one or more bypass valves and/or wastegates 17 to regulate the pressure and flow of the air that enters the downstream fuel cell, as well as to manage the cold air supply to any auxiliary heat exchangers in the system.

Compressor 12 optionally can be mechanically coupled to elongated shaft 10 via a gearbox 18 to change (increase and/or decrease) propulsor rotations per minute (RPM).

Integrated hydrogen-electric engine system 1 further includes a gas management system such as a heat exchanger 24 disposed concentrically about elongated shaft 24 and configured to control thermal and/or humidity characteristics of the compressed air from air compressor system 12 for conditioning the compressed air before entering fuel cell 26. Integrated hydrogen-electric engine system 1 further also includes a fuel source 20 of cryogenic fuel (e.g., liquid hydrogen—LH2, or cold hydrogen gas) that is operatively coupled to heat exchanger 24 via a pump 22 configured to pump the fuel from fuel source 20 to heat exchanger 24 for conditioning compressed air. In particular, the fuel, while in the heat exchanger 24, becomes gasified because of heating (e.g., liquid hydrogen converts to gas) removes heat from the system. The hydrogen gas is then heated in the heat exchanger 24 to a working temperature of the fuel cell 26, which results in a control of flow through the heat exchanger 24. In embodiments, an electric heater 19 can be coupled to or included with heat exchanger 24 to increase heat as necessary, for instance, when running under a low power regime or under cold ambient conditions. Additionally, and/or alternatively, one or more fuel cells 28, inventors 29 and motor assemblies 30 can be coupled to heat exchanger 24 for fluid communication with the cooling/heating loops and respective components as necessary. Such heating/cooling control can be managed, for instance, via controller 200 of integrated hydrogen-electric engine system 1. In embodiments, fuel source 20 can be disposed in fluid communication with one or more of fuel cells 26, inverters 28 motor assembly 30 or any other suitable component to facilitate cooling of such components.

Pump 22 also can be coaxially supported on elongated shaft 10 for actuation thereof in response to rotation of elongated shaft 10. Heat exchanger 24 is configured to cool the compressed air received from air compressor system 12 with the assistance of the pumped cryogenic fluid.

The integrated hydrogen-electric engine system 1 further includes an energy core in the form of a fuel cell 26, which may be circular, and is also coaxially supported on elongated shaft 10 (e.g., concentric) such that air channels through fuel cell 26 may be oriented in parallel relation with elongated shaft 10 (e.g., horizontally or left-to-right). Fuel cell 26 may be in the form of a proton-exchange membrane fuel cell (PEMFC). The fuel cells of the fuel cell 26 are configured to convert chemical energy liberated during the electrochemical reaction of hydrogen and oxygen to electrical energy. Depleted air and water vapor are exhausted from fuel cell 26. The electrical energy generated from fuel cell 26 is then transmitted to inverters 28 and then motor assembly 30, which are also coaxially/concentrically supported around elongated shaft 10. In aspects, integrated hydrogen-electric engine system 1 may include any number of external radiators 19 for facilitating air flow and adding, for instance, additional cooling. Notably, fuel cell 26 can include liquid cooled and/or air cooled cell types so that additional cooling may be performed by external radiators or other devices.

One or more inverters 28 is configured to convert the direct current to alternating current for actuating one or more of a plurality of motors 30 in electrical communication with the inverters 28. The motor assembly 30 is configured to drive (e.g., rotate) the elongated shaft 10 in response to the electrical energy received from fuel cell 26 for operating the components on the elongated shaft 10 as elongated shaft 10 rotates.

In aspects, one or more of the inverters 28 may be disposed between motors 30 (e.g., a pair of motors) to form a motor subassembly, although any suitable arrangement of motors 30 and inverters 28 may be provided. The motor assembly 30 can include any number of motor subassemblies supported on elongated shaft 10 for redundancy and/or safety. Motor assembly 30 can include any number of fuel cell modules 26 configured to match the power of the motors 30 and the inverters 28 of the subassemblies. In this regard, for example, during service, the fuel cell modules 26 can be swapped in/out. Each fuel cell module 26 can provide any power, such as 400 kW or any other suitable amount of power, such that when stacked together (e.g., 4 or 5 modules), total power can be about 2 megawatts on the elongated shaft 10. In embodiments, motors 30 and inverters 28 can be coupled together and positioned to share the same thermal interface so a motor casing of the motors 30 is also an inverter heat sink so only a single cooling loop goes through motor assembly 30 for cooling the inverters 28 and the motors 30 at the same time. This reduces the number of cooling loops and therefore the complexity of the system.

Up to this point, the integrated hydrogen cell-electric engine is essentially identical to the integrated hydrogen fuel cell-electric engine described in our aforesaid co-pending U.S. application Ser. No. 16/950,735, filed Nov. 17, 2020, the contents of which are incorporated herein by reference.

Referring to FIG. 2 in accordance with one aspect of the present disclosure, we provide an integrated hydrogen fuel cell-electric engine 1 for an aircraft comprising an air compressor system 100 including a plurality of electrically-and/or mechanically-driven compressors 102, 104 collectively sized to produce the airflow requirements of the hydrogen fuel cell at the maximum useable altitude, i.e., the so-called service (or certified) ceiling for the aircraft. Compressors 102, 104 are configured in series, and include an air inlet 106 at a front end of the first in line compressor 102. Compressor 102 includes a first outlet 108 connected via conduit 112 and valve 113 to an air cooler (not shown) and from there to the inlet of fuel cell 114. Compressor 102 also includes a second outlet 116 for flowing a portion of compressor 102's output via conduit 118 and valve 120 to compressor 104, where the airflow from compressor 102 may be further boosted. Compressor 104 includes an outlet 122 connected via conduit 124 to valve 113.

Controller 126 is configured to receive among other data, aircraft location, i.e., altitude, ambient air pressure, temperature and relative humidity, air stream speed and direction, etc., from various sensors (not shown), and includes a memory device including instructions for activating, controller and powering electrically driven compressors 102, 104, and valves 113 and 120 so as to provide sufficient air flow (oxygen) to the fuel cell 114 for the conditions under which the aircraft is operating.

Alternatively, as shown in FIG. 3, the integrated hydrogen cell-electric engine comprises a plurality of electrically- and/or mechanically-driven compressors 152, 154 configured in parallel. Compressors 152, 154 include inlets 156, 158, respectively, and outlets 160, 162 configured to deliver air flow through an air cooler (not shown) to the fuel cell 114.

A controller 160 is provided configured to receive among data, aircraft location, i.e., altitude, ambient air pressure, temperature and relative humidity, air stream speed and direction, etc., from various sensors (not shown), and includes a memory device including instructions for controlling and powering electrically driven compressors 152, 154 so as to provide sufficient air flow (oxygen) to the fuel cell 114 for conditions under which the aircraft is operating.

Referring to FIG. 4, in yet another aspect of the disclosure, the air compressor comprises a mechanically driven multi-stage air compressor similar to air compressor 12 shown in FIG. 1. However, in the FIG. 4 embodiment, a first stage 122 of the multi-stage air compressor is bypassed by opening its outlet 112a to atmospheric pressure. This also opens the second stage 124 of the compressor's inlet to atmospheric pressure. This may be accomplished, for example, with one or more alternate inlet doors 116 between axial compressor stages 122 and 124 which reduce pressure across the first axial compressor stage compressor blades. This achieves a similar result as not spinning the first compressor stage 122 (with a resultant small pressure drop). This method is also applicable to centrifugal compressors as will be discussed below.

A controller 180 is provided configured to receive among data, one or more of altitude, ambient air pressure, temperature and relative humidity, air stream speed and direction, etc., from various sensors (not shown), and includes a memory device including instructions for opening and closing inlet door 116.

Referring to FIG. 5, in yet another alternate embodiment, one or more centrifugal compressors 200, 202 can be on driven on the shaft 10, with one or both of the centrifugal compressors 200, 202 optionally bypassed through valving 206, 208 and conduits 210, 212 to separate electric-driven compressor(s) 214, 216 before reintroducing air to the turbines.

A controller 250 is provided configured to receive among data, aircraft location, i.e., altitude, ambient air pressure, temperature and relative humidity, air stream speed and direction, etc., from various sensors (not shown), and includes a memory device including instructions for operating electrically driven compressor(s) 214, 216 and valves 206, 208.

Referring to FIG. 6, in still yet another embodiment, we provide a two-stage turbocell 300 which comprises first and second coaxial shafts 302, 304 connected to first and second stage compressors 306, 308, respectively. First and second coaxial shafts 302, 304 are configured to run independently from one another, i.e., at different speeds. Thus the second stage compressor 308, for example, may be stationary or run more slowly than the first stage compressor 306 on the ground and at low altitude, and spun by an electric motor 310 which may be a low voltage, e.g., 12v-24v battery driven motor, and driven by fuel cell exhaust gasses at higher altitudes where more compression is required. Completing this embodiment are heat exchangers 324, fuel cell 326, inverters 328, motor 330 etc. similar to the corresponding components discussed above relative to FIG. 1.

A controller 350 is provided configured to receive among data, aircraft location, i.e., altitude, ambient air pressure, temperature and relative humidity, air stream speed and direction, etc., from various sensors (not shown), and includes a memory device including instructions for operating electric motor 310.

Referring to FIG. 7, in still yet another embodiment, a low voltage, e.g., 12v to 28v battery powered “starter motor” 400 may be provided to start up the hydrogen fuel cell powered system, by driving one or more electrically driven compressors 410.

As in the case of the other embodiments discussed above, a controller 450 is configured to receive among data, one or more of altitude, ambient air pressure, temperature and relative humidity, air stream speed and direction, etc., from various sensors (not shown), and includes a memory device including instructions for operating motor 400.

Various changes may be made in the above disclosure without departing from the spirit and scope thereof.

1-10. (canceled)

11. An integrated hydrogen-electric engine comprising:
an air compressor system;
a hydrogen fuel source;
a fuel cell;
an elongated shaft connected to the air compressor system and/or a propulsor; and
a motor assembly disposed in electrical communication with the fuel cell, wherein the air compressor system includes a plurality of electrically driven compressors configured to run in series, wherein the plurality of electrically driven compressors are connected via valves.

12. The integrated hydrogen-electric engine of claim 11, wherein the valves comprise pressure balancing valves.

13. The integrated hydrogen-electric engine of claim 11, further including a controller configured to control operation of the valves.

14. An integrated hydrogen-electric engine comprising:
an air compressor system;
a hydrogen fuel source;
a fuel cell;
an elongated shaft connected to the air compressor system and/or a propulsor; and
a motor assembly disposed in electrical communication with the fuel cell,
wherein the air compressor system includes a plurality of compressors configured to run in parallel.

15. The integrated hydrogen-electric engine of claim 14, wherein the plurality of compressors are coaxially arranged on the elongated shaft, wherein the plurality of compressors have variable pitch vanes or variable inlet guide vanes.

16. The integrated hydrogen-electric engine of claim 15, further including a controller configured to control operation of the variable pitch vanes or variable inlet guide vanes.

17. An integrated hydrogen-electric engine comprising:
an air compressor system;
a hydrogen fuel source;
a fuel cell;
an elongated shaft connected to the air compressor system and/or a propulsor; and
a motor assembly disposed in electrical communication with the fuel cell, wherein the air compressor system comprises a plurality of bladed compressors axially arranged on the elongated shaft, and further including one or more air inlets and/or outlets configured to open and close to selectively alter air flow across the compressor blades, and
further including a controller configured for controlling operation of the inlets and outlets.

18. The integrated hydrogen-electric engine of claim 17, wherein the compressors comprise centrifugal compressors.

19. An integrated hydrogen-electric engine comprising:
an air compressor system;
a hydrogen fuel source;
a fuel cell;
an elongated shaft connected to the air compressor system and/or a propulsor; and
a motor assembly disposed in electrical communication with the fuel cell, wherein the air compressor system includes a centrifugal air compressor driven by the elongated shaft, and an electrically driven air compressor, configured to boost the centrifugal air compressor, wherein the electrically driven compressor is connected to an inlet of the centrifugal compressor through valves.

20. The integrated hydrogen-electric engine of claim 19, further including a controller configured to control operation of the valves.
